(19) United States
(12) Patent Application Publication
(10) Pub. No.: US 2025/0054996 A1
(43) Pub. Date: Feb. 13, 2025

(54) NEGATIVE ELECTRODE FOR ZINC BATTERY, AND ZINC BATTERY

(71) Applicant: Energywith Co., Ltd., Chiyoda-ku, Tokyo (JP)

(72) Inventor: Kunihiro KUSHIBE, Chiyoda-ku, Tokyo (JP)

(21) Appl. No.: 18/851,290

(22) PCT Filed: Feb. 10, 2023
(86) PCT No.: PCT/JP2023/004536

§ 371 Date: Sep. 26, 2024

(30) Foreign Application Priority Data
Apr. 7, 2022 (JP) 2022-063814

(51) Int. Cl. H01M 4/80; H01M 4/02; H01M 4/24; H01M 4/38; H01M 4/66

(52) U.S. Cl. CPC H01M 4/80; H01M 4/244; H01M 4/38; H01M 4/662; H01M 4/667; H01M 2004/021; H01M 2004/027

(57) ABSTRACT

A negative electrode 1 for a zinc battery includes a current collector 2, and a negative electrode material layer 3 fixed to the current collector 2. The current collector 2 has a plurality of holes 6 which pass through the current collector 2 in a thickness direction and are filled with the negative electrode material layer 3. An inner area of each of the plurality of holes 6 in a cross-section orthogonal to the thickness direction is larger than 0.5 mm² and less than 19.6 mm².

### TECHNICAL FIELD

The present disclosure relates to a negative electrode for a zinc battery, and the zinc battery.

### BACKGROUND ART

As a zinc battery, a nickel-zinc battery, a zinc-air battery, a silver-zinc battery, and the like are known. For example, since the nickel-zinc battery is an aqueous battery that uses an aqueous electrolytic solution of potassium hydroxide, there is known that the nickel-zinc battery has high stability, and has a high electromotive force as an aqueous battery by a combination of a zinc electrode and a nickel electrode. In addition, in addition to excellent input/output performance, since the nickel-zinc battery is inexpensive, applicability to industrial applications (for example, a backup power supply and the like) and automotive applications (for example, a hybrid vehicle and the like) have been examined. Patent Literature 1 discloses a technology relating to the nickel-zinc battery.

### CITATION LIST

### Patent Literature

Patent Literature 1: Japanese Unexamined Patent Publication No. S58-126665

### SUMMARY OF INVENTION

### Technical Problem

For example, as described in Patent Literature 1, dendrites are formed on a negative electrode of the zinc battery due to precipitation of zinc. While the zinc battery is repetitively used, the dendrites grow larger, and eventually short-circuit the negative electrode and a positive electrode. Accordingly, the faster the dendrites grow, the shorter the lifespan of the zinc battery becomes. An object of one aspect of the present disclosure is to provide a negative electrode for a zinc battery which is capable of extending a lifespan of the zinc battery by retarding a growth rate of a dendrite, and the zinc battery.

### Solution to Problem

[1] A negative electrode for a zinc battery according to an aspect of the present disclosure includes: a current collector; and a negative electrode material layer fixed to the current collector. The current collector has a plurality of holes which pass through the current collector in a thickness direction and are filled with the negative electrode material layer. The plurality of holes include a hole having an inner area of larger than 0.5 mm² and less than 19.6 mm² in a cross-section orthogonal to the thickness direction.

[2] In the negative electrode for a zinc battery according to [1], a shape of the cross-section of each of the plurality of holes may be a circular shape, and the plurality of holes may include a hole having an inner diameter of larger than 0.8 mm and less than 5 mm in the cross-section. [3] In the negative electrode for a zinc battery according to [1] or [2], an opening ratio of the current collector may be 35% or more. [4] The negative electrode for a zinc battery according to any one of [1] to [3], the current collector may include a conductive base material, and a tin plating film that covers at least a part of a surface of the base material. [5] In this case, the base material may mainly contain carbon steel. [6] In the negative electrode for a zinc battery according to any one of [1] to [5], the negative electrode material layer may contain a zinc-containing component and a binder. [7] A zinc battery according to another aspect of the present disclosure includes: the negative electrode for a zinc battery according to any one of [1] to [6]; and a positive electrode.

### Advantageous Effects of Invention

According to the aspect of the present disclosure, it is possible to provide a negative electrode for a zinc battery which is capable of extending a lifespan of the zinc battery by retarding a growth rate of a dendrite, and the zinc battery.

### BRIEF DESCRIPTION OF DRAWINGS

FIG. 1 is a front elevational view illustrating a negative electrode for a zinc battery of an embodiment.

FIG. 2 is a cross-sectional view taken along line II-II in FIG. 1.

FIG. 3 Parts of (a) to (c) in FIG. 3 are front elevational views illustrating a negative electrode for a zinc battery according to a modification example.

FIG. 4 is a view schematically illustrating a configuration of a nickel-zinc battery.

### DESCRIPTION OF EMBODIMENTS

In numerical value ranges described in stages in this specification, an upper limit value or a lower limit value of a numerical value range of any stage may be arbitrarily combined with an upper limit value or a lower limit value of a numerical value range of another stage. In a numerical value range described in this specification, an upper limit value or a lower limit value of the numerical value range may be substituted with a value described in an example. Materials exemplified in this specification, one kind may be used alone or two or more kinds may be used in combination unless otherwise stated. In this specification, a “film” or a “layer” includes not only a structure having a shape formed on an entire surface but also a structure having a shape formed partially when observed with a plan view.

Hereinafter, embodiments of the present disclosure will be described in detail. However, the invention is not limited to the following embodiments, and can be executed in various modifications within a range of the gist. In respective drawings, the size of a constituent element is conceptual, and a relative relationship in size between constituent elements is not limited to relationship shown in the respective drawings.

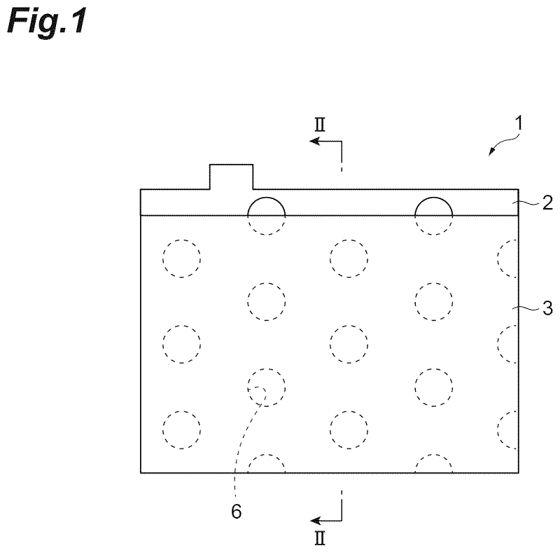

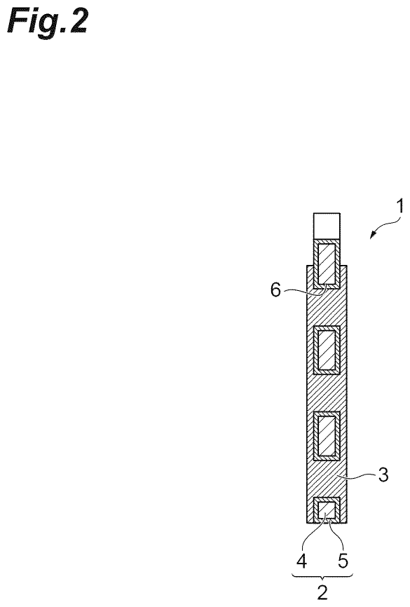

FIG. 1 is a front elevational view illustrating a negative electrode 1 for a zinc battery of this embodiment. FIG. 2 is a cross-sectional view taken along line II-II of FIG. 1. As illustrated in FIG. 1 and FIG. 2, the negative electrode 1 for a zinc battery includes a current collector (negative electrode current collector) 2 and a negative electrode material layer 3. The current collector 2 constitutes a conductive path of a current from the negative electrode material layer 3. The current collector 2 includes a base material 4 and a tin plating film 5.

The base material 4 consists of a conductive material, and mainly contains copper or carbon steel. In an example, the base material 4 consists of only copper, or only carbon steel. The base material 4 has a shape such as a flat plate shape. The base material 4 may be a punched metal plate consisting of carbon steel. The carbon steel has conductivity and alkali resistance, and is stable even at a reaction potential of the negative electrode. For example, the base material 4 may be a cold-rolled steel plate, or may be obtained by processing the cold-rolled steel plate. Examples of the processing include bending, pressing, and/or drawing. For example, the thickness of the base material 4 may be 0.01 mm or more, or 0.5 mm or less. A shape of the base material 4 when viewed from a front side may be various shapes such as a rectangular shape and a square shape. An area of the base material 4 when viewed from the front side may be, for example, 2000 mm² or more and 20000 mm² or less.

The tin plating film (tin film) 5 covers the entirety or a part of a surface of the base material 4. In a case where at least a part of the base material 4 is covered with the tin plating film 5, oxidation of the base material 4 can be suppressed. In the negative electrode, a decomposition reaction of an electrolytic solution progresses as a side reaction, and a hydrogen gas is generated, but in a case where at least a part of the base material 4 is covered with the tin plating film 5, the progression of the side reaction can be suppressed. The film thickness of the tin plating film 5 may be, for example, 0.1 μm or more and 5 μm or less. In a case where the surface of the base material 4 consists of copper, the current collector 2 may not include the tin plating film 5.

The current collector 2 includes a plurality of holes 6 which pass through the current collector 2 in a thickness direction. The plurality of holes 6 may be two-dimensionally dispersed and arranged according to a certain rule within a plane orthogonal to the thickness direction of the current collector 2. In one example, the plurality of holes 6 are arranged so that centers of gravity match lattice points of a square lattice or a regular triangular lattice. In a case where the tin plating film 5 is provided on the surface of the base material 4, the tin plating film 5 is formed on an inner side of each of the plurality of holes 6. In the following description, in a case where the tin plating film 5 is provided on the surface of the base material 4, an inner area and an inner diameter of each of the plurality of holes 6 are defined as follows. That is, the inner area of each of the plurality of holes 6 represents an inner area of each of the plurality of holes 6 defined by a surface of the tin plating film 5 formed on an inner side of the holes 6. The inner diameter of each of the plurality of holes 6 represents an inner diameter of each of the plurality of holes 6 defined by the surface of the tin plating film 5 formed on the inner side of the holes 6. In a case where the tin plating film 5 is not provided on the surface of the base material 4, the inner area and the inner diameter of each of the plurality of holes 6 are defined as follows. That is, the inner area of the plurality of holes 6 represents an inner area of the plurality of holes 6 defined by the surface of the base material 4 on an inner side of the holes 6. The inner diameter of the plurality of holes 6 represents an inner diameter of the plurality of holes 6 defined by the surface of the base material 4 on the inner side of the holes 6.

In a case where the shape of a cross-section, which is orthogonal to the thickness direction of the current collector 2 (in other words, a cross-section parallel to the surface of the current collector 2), of each of the plurality of holes 6 is a circular shape having an inner diameter R [mm], the inner area of each of the plurality of holes 6 in the cross-section orthogonal to the thickness direction of the current collector 2 is calculated as π(R/2)² [mm²]. In a case where inner areas of the holes 6 are different depending on a position in the thickness direction of the cross-section orthogonal to the thickness direction of the current collector 2, the inner area of the holes 6 is defined as the smallest inner area among the inner areas. In a case where inner diameters of the holes 6 are different depending on a position in the thickness direction of the cross-section orthogonal to the thickness direction of the current collector 2, the inner diameter of the hole 6 is defined as the smallest inner diameter among the inner diameters. In this embodiment, the plurality of holes 6 include one or more holes 6 having an inner area of larger than 0.5 mm² and less than 19.6 mm². In other words, the plurality of holes 6 include one or more holes 6 having the inner diameter R of larger than 0.8 mm and less than 5 mm. More preferably, the plurality of holes 6 include one or more holes 6 having the inner area of more than 1.7 mm² and less than 7.0 mm². In other words, the plurality of holes 6 include one or more holes 6 having the inner diameter R of more than 1.5 mm and less than 3 mm. More preferably, the plurality of holes 6 include one or more holes 6 having an inner area of more than 1.7 mm² and less than 3.1 mm². In other words, the plurality of holes 6 includes one or more holes 6 having an inner diameter R of more than 1.5 mm and less than 2 mm.

Two or more holes 6 among the plurality of holes 6 may satisfy any numerical range among the numerical value ranges, or all of the plurality of holes 6 may satisfy any numerical value range among the numerical value ranges. An average value of all of the holes 6 may satisfy any numerical value range among the numerical value range. Mains holes 6 among the plurality of holes 6 may satisfy any numerical value range among the numerical value ranges. For example, the main holes 6 represent two or more holes 6 which occupy the opening ratio of the current collector 2 in a total ratio of 80% or more and have a uniform size.

The opening ratio of the current collector 2 is defined by a ratio (B/A) of a total sum B of the inner areas of the plurality of holes 6 to the area A defined by an outer edge of a portion covered with the negative electrode material layer 3 in the current collector 2. For example, the opening ratio of the current collector 2 is 35% or more, preferably 40% or more, more preferably 45% or more, and still more preferably 50% or more. For example, the opening ratio of the current collector 2 is 70% or less.

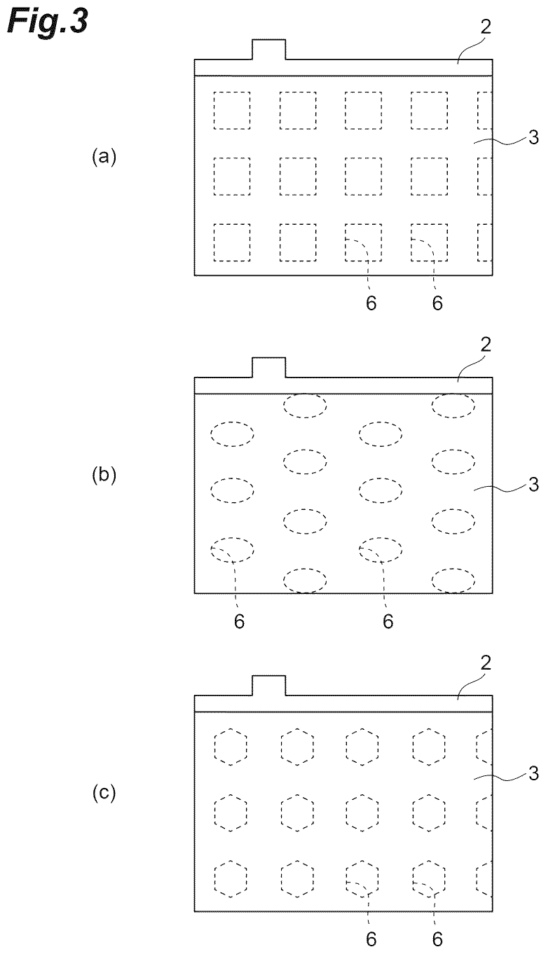

The shape of the cross-section orthogonal to the thickness direction of the current collector 2 in each of the plurality of holes 6 is not limited to the circular shape. Parts of (a) to (c) in FIG. 3 illustrate cases where the shape of the holes 6 in the cross-section orthogonal to the thickness direction is a quadrangle, an ellipse, and a polygon, respectively. In a case where the shape of the holes 6 is a quadrangle, the quadrangle includes a square, a parallelogram, a trapezoid, and a quadrangle with round corners. In a case where the shape of the holes 6 is a rectangle, a longitudinal direction thereof may or may not be aligned between the plurality of holes 6. In a case where the longitudinal direction of the rectangle is aligned between the plurality of holes 6, the longitudinal direction thereof may conform to a vertical direction or a horizontal direction when installing the zinc battery. The shape of the holes 6 is not limited to the ellipse, and may be, for example, an elongated circle. A major axis direction of the ellipse and the elongated circle may be or may not be aligned between the plurality of holes 6. In a case where the major axis direction of the ellipse or the elongated circle is aligned between the plurality of holes 6, the major axis direction may conform to the vertical direction or the horizontal direction when installing the zinc battery. In a case where the shape of the holes 6 is a polygon, for example, various numbers of corners such as a triangle, a hexagon, and an octagon may be employed. The polygon may be a regular polygon.

The negative electrode material layer 3 is a layer formed from a negative electrode material. When the negative electrode material is filled between the plurality of holes 6 of the current collector 2, the negative electrode material layer 3 is fixed to the current collector 2 while being supported to the current collector 2. The negative electrode material layer 3 contains a zinc-containing component. Examples of the zinc-containing component include metallic zinc, a zinc oxide, and a zinc hydroxide. The zinc-containing component functions as a negative electrode active material in the zinc battery, and may also be referred to as a raw material of the negative electrode active material. From the viewpoint of obtaining excellent lifespan performance, the content of the zinc-containing component is preferably 50 mass % or more, still more preferably 70 mass % or more, and still more preferably 75 mass % or more on the basis of the total mass of the negative electrode material. From the viewpoint of obtaining the excellent lifespan performance, the content of the zinc-containing component is preferably 95 mass % or less, still more preferably 90 mass % or less, and still more preferably 85 mass % or less on the basis of the total mass of the negative electrode material.

The negative electrode material layer 3 may further contain additives such as a binder (binding agent) and a conductive agent. Examples of the binder include a hydrophilic or hydrophobic polymer. Specifically, for example, polytetrafluoroethylene (PTFE), hydroxyethyl cellulose (HEC), carboxymethyl cellulose (CMC), polyethylene oxide, polyethylene, polypropylene, and the like can be used as the binder. The binder can be used alone or in combination of a plurality of kinds. Viscosity of the binder may be, for example, 3000 to 6000 cp at room temperature (25° C.) in a 2% aqueous solution, or may be approximately 25 cp at room temperature (25° C.) in a 60% aqueous solution. The content of the binder is, for example, 0.5 to 10 mass % with respect to 100 mass % of zinc-containing component. Examples of the conductive material include an indium compound such as an indium oxide. The content of the conductive material is, for example, 1 to 20 mass % with respect to 100 mass % of zinc-containing component.

Examples of a method of manufacturing the negative electrode 1 for a zinc battery includes a method of preparing the current collector 2, disposing negative electrode material paste on the current collector 2, and drying the negative electrode material paste. The negative electrode material paste may be disposed on the current collector 2, for example, by a method in which the negative electrode material paste is rolled to form a sheet and the sheet is stuck to the current collector 2. For example, the negative electrode material paste may be applied to or filled into the current collector 2 to be disposed on the current collector 2 and on an inner side of the plurality of holes 6. A method of applying or filling the negative electrode material paste is not particularly limited, and may be appropriately selected depending on a shape of the current collector 2, a shape of the negative electrode material layer 3, or the like. When a negative electrode material paste layer consisting of the negative electrode material paste is dried, the negative electrode material layer 3 consisting of the negative electrode material is formed. The density of the negative electrode material layer 3 may be increased by pressing or the like as necessary. The negative electrode material paste contains a raw material of the negative electrode material, and a solvent (for example, water). The negative electrode material paste can be obtained by adding the solvent (for example, water) to a raw material of the negative electrode material and by kneading the resultant mixture. Examples of the raw material of the negative electrode material include a zinc-containing component and an additive.

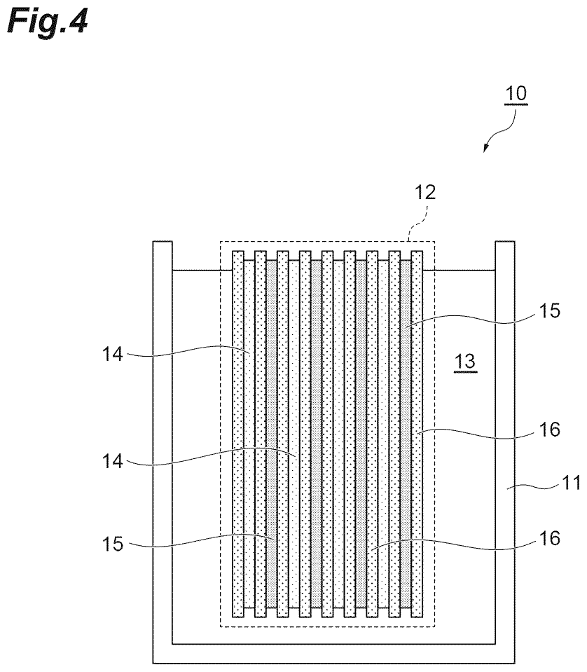

Next, description will be given of a nickel-zinc battery as an example of the zinc battery of this embodiment that can employ the above-described negative electrode 1 for a zinc battery. In the nickel-zinc battery, a negative electrode is a zinc (Zn) electrode, and a positive electrode is a nickel (Ni) electrode. FIG. 4 is a view schematically illustrating a configuration of a nickel-zinc battery 10.

The nickel-zinc battery 10 of this embodiment includes, for example, a battery case 11, and an electrode group (for example, an electrode plate group) 12 and an electrolytic solution 13 accommodated in the battery case 11. The nickel-zinc battery 10 may be a battery that is chemically converted or that is not chemically converted. In a case where the nickel-zinc battery 10 is a nickel-zinc battery that is not chemically converted, the electrodes (the negative electrode and the positive electrode) are electrodes which are not chemically converted, and in a case where the nickel-zinc battery 10 is a chemically converted nickel-zinc battery, the electrodes are chemically converted electrodes.

The electrode group 12 includes, for example, a negative electrode (for example, a negative electrode plate) 14, a positive electrode (for example, a positive electrode plate) 15, and a separator 16 provided between the negative electrode 14 and the positive electrode 15. The electrode group 12 may include a plurality of the negative electrodes 14, a plurality of the positive electrodes 15, and a plurality of the separators 16. For example, the plurality of negative electrodes 14 may be connected by a strap, and the plurality of positive electrodes 15 may be connected by a strap. The negative electrode 14 has the configuration of the negative electrode 1 for a zinc battery. For example, the separator 16 is a separator having a shape such as a flat plate shape and a sheet shape. Examples of the separator 16 include a polyolefin-based microporous membrane, a nylon-based microporous membrane, an oxidation-resistant ion-exchange resin membrane, a cellophane-based recycled resin membrane, an inorganic-organic separator, and a polyolefin-based nonwoven fabric.

The positive electrode 15 includes a positive electrode current collector, and a positive electrode material supported to the positive electrode current collector. The positive electrode current collector constitutes a conduction path of a current from the positive electrode material. For example, the positive electrode current collector has a shape such as a flat plate shape and a sheet shape. The positive electrode current collector may be a current collector having a three-dimensional network structure constituted by a foamed metal, an expanded metal, a punched metal, or a felt-shaped object of a metal fiber, or the like. The positive electrode current collector consists of a material having conductivity and alkali resistance. As the material, for example, a material that is stable even at a reaction potential of the positive electrode can be used. Examples of the material stable even at the reaction potential of the positive electrode include a material that has an oxidation-reduction potential greater than the reaction potential of the positive electrode and a material that forms a protective film such as an oxidized film on a base material surface in an alkali aqueous solution for stabilization. In the positive electrode, a decomposition reaction of the electrolytic solution progresses as a side reaction and generates an oxygen gas, but a material with a high oxygen overvoltage is preferable from the viewpoint that the progress of the side reaction can be suppressed. Specific examples of the material that constitutes the positive electrode current collector include platinum, nickel (foamed nickel or the like), and a metallic material (copper, brass, steel, and the like) plated with a metal such as nickel. Among these, a positive electrode current collector consisting of foamed nickel can be preferably used. From the viewpoint of further improving high-rate discharge performance, it is preferable that at least a portion (positive electrode material supporting portion) that supports the positive electrode material in the positive electrode current collector consists of the foamed nickel.

The positive electrode material shows, for example, a layered shape. That is, the positive electrode may include a positive electrode material layer. The positive electrode material layer may be formed on the positive electrode current collector. In a case where the positive electrode material supporting portion of the positive electrode current collector has a three-dimensional network structure, the positive electrode material may be filled between meshes of the positive electrode current collector to form the positive electrode material layer. The positive electrode material contains a nickel-containing positive electrode active material. Examples of the positive electrode active material include nickel oxyhydroxide (NiOOH) and nickel hydroxide. For example, the positive electrode material contains nickel oxyhydroxide in a fully charged state, and contains nickel hydroxide in an end of discharged state. For example, the content of the positive electrode active material may be within a range of 50 mass % to 95 mass % on the basis of the total mass of the positive electrode material.

The positive electrode material may further contain other components other than the positive electrode active material as the additive. Examples of the additive include a binder (a binding agent), a conductive agent, and an expansion inhibitor. Examples of the binder include hydrophilic or hydrophobic polymers. Specifically, for example, carboxymethyl cellulose (CMC), hydroxyethyl cellulose (HEC), hydroxypropyl methyl cellulose (HPMC), sodium polyacrylate (SPA), fluorine-based polymers (polytetrafluoroethylene (PTFE), and the like) can be used as the binder. For example, the content of the binder is within a range of 0.01 mass % to 5 mass % with respect to 100 mass % of positive electrode active material. Examples of the conductive material include cobalt compounds (metallic cobalt, cobalt oxide, cobalt hydroxide, and the like). For example, the content of the conductive agent is within a range of 1 mass % to 20 mass % with respect to 100 mass % of positive electrode active material. Examples of the expansion inhibitor include zinc oxide. For example, the content of the expansion inhibitor is within a range of 0.01 mass % to 5 mass % with respect to 100 mass % of positive electrode active material.

The electrolytic solution 13 contains, for example, a solvent and an electrolyte. Examples of the solvent include water (for example, ion-exchanged water). As the electrolyte, basic compounds and the like can be exemplified, and examples thereof include alkaline metal hydroxides such as potassium hydroxide (KOH), sodium hydroxide (NaOH), and lithium hydroxide (LiOH), and the like. The electrolytic solution may contain components other than the solvent and the electrolyte, and may contain, for example, potassium phosphate, potassium fluoride, potassium carbonate, sodium phosphate, sodium fluoride, zinc oxide, antimony oxide, titanium dioxide, a nonionic surfactant, an anionic surfactant, and the like.

For example, the nickel-zinc battery 10 described above can be obtained by a method including an assembly process of assembling constituent members including the negative electrode 14 and the positive electrode 15 to obtain the nickel-zinc battery 10. In the assembly process, for example, first, positive electrodes 15 and negative electrodes 14 which are not chemically converted are stacked alternately with the separator 16 interposed therebetween, and the positive electrodes 15 are connected by a strap and the negative electrodes 14 are connected by a strap to prepare the electrode group 12. Next, the electrode group 12 is disposed inside the battery case 11, and a lid is bonded to an upper surface of the battery case 11 to obtain the nickel-zinc battery 10 that is not chemically converted. Next, the electrolytic solution 13 is injected into the battery case 11, and is left as is for a certain time. Then, the nickel-zinc battery 10 is obtained by performing chemical conversion by performing charging under predetermined conditions.

Hereinbefore, description has been given of the nickel-zinc battery 10 in which the positive electrode 15 is the nickel electrode, but the zinc battery may be a zinc-air battery in which the positive electrode is an air electrode, or a silver-zinc battery in which the positive electrode is silver oxide electrode. As the silver oxide electrode of the silver-zinc battery, a known silver oxide electrode that is used in the silver-zinc battery can be used. The silver oxide electrode contains, for example, silver oxide (I). As air electrode of the zinc-air battery, a known air electrode that is used in the zinc-air battery can be used. The air electrode contains, for example, an air electrode catalyst, an electronically conductive material, and the like. As the air electrode catalyst, an air electrode catalyst that also functions as the electronically conductive material can be used.

As the air electrode catalyst, a catalyst that can function as a positive electrode in the zinc-air battery, and various air electrode catalysts which can use oxygen as a positive electrode active material can be used. Examples of the air electrode catalyst include carbon-based materials (graphite, and the like) having an oxidation-reduction catalyst function, metallic materials (platinum, nickel, and the like) having an oxidation-reduction catalyst function, and inorganic oxide materials (perovskite-type oxides, manganese dioxide, nickel oxide, cobalt oxide, spinel oxide, and the like) having an oxidation-reduction catalytic function. A shape of the air electrode catalyst is not particularly limited, and may be a particle shape. The amount of the air electrode catalyst used in the air electrode may be within a range of 5 vol % to 70 vol %, within a range of 5 vol % to 60 vol %, or within a range of 5 vol % to 50 vol % with respect to the total amount of the air electrode.

As the electronically conductive material, a material that has conductivity and allows electronic conduction between the air electrode catalyst and the separator. Examples of the electronically conductive material include carbon black such as ketjen black, acetylene black, channel black, furnace black, lamp black, and thermal black; graphite such as natural graphite such as flake graphite, artificial graphite, and expanded graphite; conductive fibers such as carbon fibers and metal fibers; metal powders such as copper, silver, nickel, and aluminium; organic electronically conductive materials such as polyphenylene derivatives; and any mixtures of these. A shape of the electronically conductive material may be a powder shape or the other shapes. It is preferable that the electronically conductive material is used in a form of causing a continuous phase in a thickness direction of the air electrode. For example, the electronically conductive material may be a porous material. The electronically conductive material may be a form of a mixture or a composite with the air electrode catalyst, or an air electrode catalyst that also functions as the electronically conductive material as described above. The amount of the electronically conductive material used in the air electrode may be within a range of 10 vol % to 80 vol %, within a range of 15 vol % to 80 vol %, or within a range of 20 vol % to 80 vol % with respect to the total amount of the air electrode.

Description will be given of an effect that can be obtained by the negative electrode 1 for a zinc battery and the nickel-zinc battery 10 according to the embodiment described above. As described above, in the negative electrode 1 for a zinc battery of this embodiment, the current collector 2 has the plurality of holes 6 which pass through the current collector 2 in a thickness direction thereof, and are filled with the negative electrode material layer 3. In addition, the plurality of holes 6 include a hole 6 having an inner area of larger than 0.5 mm² and less than 19.6 mm² in a cross-section orthogonal to the thickness direction of the current collector 2. In a case where the cross-sectional shape of each of the plurality of holes 6 is a circular shape, the plurality of holes 6 includes a hole 6 having an inner diameter R of larger than 0.8 mm and less than 5 mm in the cross-section.

In a case where the inner area of the hole 6 is larger than 0.5 mm² and less than 19.6 mm², or the inner diameter R of the hole 6 is larger than 0.8 mm and less than 5 mm, as illustrated in the following example, the lifespan of the zinc battery in a cycle test can be extended. Results are considered to be due to the following operations. That is, in a case where the inner area of the hole 6 is larger than 0.5 mm², or the inner diameter R of the hole 6 is larger than 0.8 mm, since fluidity of the electrolytic solution 13 inside the negative electrode 1 for a zinc battery increases, reaction uniformity is improved. In a case where the inner area of the hole 6 is less than 19.6 mm², or the inner diameter R is less than 5 mm, coating unevenness of the negative electrode material paste between the hole 6 and the surface of the base material 4 excluding the hole 6 is reduced, and the uniformity of the thickness of the negative electrode material layer 3 is improved, and thus the reaction uniformity is improved. When the reaction uniformity is improved, growth of dendrite due to precipitation of zinc is retarded, and time until the negative electrode 14 and the positive electrode 15 are short-circuited due to the dendrite is lengthened. As a result, the lifespan of the zinc battery is extended. The dendrite growth due to precipitation of zinc is remarkable at a high temperature (for example, 70° C.), the above-described effect is more remarkable at a high temperature.

The inner area of the hole 6 may be more than 1.7 mm² and less than 7.0 mm². In addition, the inner diameter R of the hole 6 may be more than 1.5 mm and less than 3 mm. In this case, as illustrated in the following example, the lifespan of the zinc battery in the cycle test can be more extended. This result is also considered to be due to improvement of reaction uniformity, delay of the dendrite growth caused by precipitation of zinc, and lengthening of time until the negative electrode 14 and the positive electrode 15 are short-circuited due to dendrite.

As in this embodiment, the current collector 2 may include the conductive base material 4, and the tin plating film 5 that covers at least a part of the surface of the base material 4. According to this, even in a case where electrical resistivity of the base material 4 is large, electrical performance as the current collector 2 can be sufficiently exhibited. Therefore, for example, a material having high electrical resistivity such as carbon steel can be used as a main constituent material of the current collector 2, and the option for the constituent material of the current collector 2 can be increased. In this case, the base material 4 may mainly contain carbon steel. According to this, the manufacturing cost of the negative electrode 1 for a zinc battery can be further reduced, for example, as compared with a case of using copper as the material of the base material 4.

As in this embodiment, the negative electrode material layer 3 may contain the zinc-containing component and the binder. In this case, it is possible to simply form the negative electrode material layer 3 by applying the negative electrode material paste.

### EXAMPLES

Hereinafter, the contents of the present disclosure will be described in more detail with reference to examples, but the invention is not limited to the following examples.

### [Preparation of Negative Electrode]

As the negative electrode current collector, five Samples A to E shown in the following Table 1 were manufactured. Specifically, tin-plated punched steel plates having a hole diameter and an opening ratio of each of Samples A to E were prepared. Samples A to E are different in the inner diameter and the opening ratio of the circular hole 6, and the other configurations are the same each other. The opening ratio is 50% or more in any sample.

TABLE 1

| | Sam- | Sam- | Sam- | Sam- | Sam- |
|---|---|---|---|---|---|
| Item | ple A | ple B | ple C | ple D | ple E |
| Inner diameter of hole (mm) | 0.8 | 1.5 | 2 | 3 | 5 |
| Inner area of hole (mm²) | 0.5 | 1.7 | 3.1 | 7.0 | 19.6 |
| Opening ratio (%) | 58.0 | 51.0 | 58.0 | 51.0 | 53.6 |

Next, predetermined amounts of zinc oxide, metallic zinc, a surfactant, HEC, and ion-exchanged water were weighed and mixed, and the obtained mixed solution was stirred to prepare negative electrode material paste. At this time, a mass ratio of a solid content was adjusted to “zinc oxide:metallic zinc:HEC:surfactant=84.5:11.5:3.5:0.5”. A moisture amount of the negative electrode material paste was adjusted to 32.5 mass % on the basis of the total mass of the negative electrode material paste. Next, the negative electrode material paste was applied onto the negative electrode current collector, and was dried at 80° C. for 30 minutes. Then, the resultant object was press-molded with a roll press to obtain a negative electrode including the negative electrode material layer which was not chemically converted.

### [Preparation of Electrolytic Solution]

Potassium hydroxide (KOH) and lithium hydroxide (LiOH) were added to the ion-exchanged water and mixed to prepare an electrolytic solution (a concentration of potassium hydroxide: 30 mass %, and a concentration of lithium hydroxide: 1 mass %).

### [Preparation of Positive Electrode]

A lattice body that consists of foamed nickel and has a porosity of 95% was prepared, and the lattice body was press-molded to obtain a positive electrode current collector. Next, predetermined amounts of cobalt-coated nickel hydroxide powder, metallic cobalt, cobalt hydroxide, yttrium oxide, CMC, PTFE, and ion-exchanged water were weighed and mixed, and the mixed solution was stirred to prepare positive electrode material paste. At this time, the mass ratio of a solid content was adjusted to “nickel hydroxide:metallic cobalt:yttrium oxide:cobalt hydroxide:CMC:PTFE=88:10.3:1:0.3:0.3:0.1”. The moisture amount of the positive electrode material paste was adjusted to 27.5 mass % on the basis of the total mass of the positive electrode material paste. Next, the positive electrode material paste was applied to a positive electrode material supporting portion of the positive electrode current collector, and was dried at 80° C. for 30 minutes. Then, the resultant object was press-molded with a roll press to obtain a positive electrode including the positive electrode material layer which is not chemically converted.

### [Preparation of Separator]

For the separator, Celgard (registered trademark) 2500 was used a microporous membrane, and VL100 (manufactured by NIPPON KODOSHI CORPORATION) was used a non-woven fabric. The microporous membrane was subjected to a hydrophilic treatment with a surfactant Triton (registered trademark)-X100 (manufactured by The Dow Chemical Company) before battery assembly. The hydrophilic treatment was performed by a method in which the microporous membrane was immersed in an aqueous solution containing 1 mass % of Triton-X100 for 24 hours, and was dried at room temperature for one hour. Furthermore, the microporous membrane was cut to a predetermined size, was folded in half, and was processed into a bag shape by thermally welding a side surface thereof. One sheet of the positive electrode that is not chemically converted and one sheet of the negative electrode that is not chemically converted were accommodated in the microporous membrane processed into the bag shape. As the non-woven fabric, a non-woven fabric cut to a predetermined size was used.

### [Preparation of Nickel-Zinc Battery]

Two sheets of positive electrodes accommodated in a bag-shaped microporous membrane and three sheets of negative electrodes (Sample A) accommodated in a bag-shaped microporous membrane were alternately stacked, the non-woven fabric was interposed between the positive electrode and the negative electrode, and electrode plates having the same polarity were connected by a strap to prepare an electrode group (electrode plate group). The electrode group was disposed in a battery case, and a lid was bonded to an upper surface of the battery case to obtain a nickel-zinc battery that is not chemically converted. Next, an electrolytic solution was injected into the battery case of the nickel-zinc battery that is not chemically converted, and was left as is for 24 hours. Then, charging was performed under conditions of 20 mA and 15 hours to prepare a nickel-zinc battery having a nominal capacity of 320 mAh. Nickel-zinc batteries including negative electrodes of Sample B to E were prepared in a similar manner.

### [Cycle Test]

A cycle test, in which charging until a current value is attenuated to 16 mA (0.05 C) and discharging at a constant current of 105.7 mA (0.33 C) until a battery voltage reaches 1.1 V are set as one cycle, was performed by using nickel-zinc batteries respectively including the negative electrode current collector of Samples A to E under constant voltage conditions of a temperature of 70° C., a current value of 105.7 mA (0.33 C), and a voltage of 1.88 V. “C” described above relatively represents the magnitude of a current until a rated capacity is discharged at a constant current from a fully charged state. “C” described above represents “discharged current value (A)/battery capacity (Ah)”. For example, a current at which the rated capacity can be discharged for one hour is expressed as “1 C” and a current at which the rated capacity can be discharged for two hours is expressed as “0.5 C”.

In the cycle test, short-circuit resistance was evaluated by a charging rate obtained by dividing a charging capacity for every cycle by a discharging capacity, and the number of cycles at a point of time when the charging rate exceeded 110% was determined as cycles at which short-circuiting is shown and was set as a lifespan. The following Table 2 shows a cycle lifespan of nickel-zinc batteries respectively including the negative electrode current collectors of Samples A to E.

TABLE 2

| | Sam- | Sam- | Sam- | Sam- | Sam- |
|---|---|---|---|---|---|
| Item | ple A | ple B | ple C | ple D | ple E |
| 70° C. cycle lifespan (cycle) | 36 | 126 | 113 | 76 | 23 |

As shown in Table 2, the cycle lifespan of the nickel-zinc battery including the negative electrode current collector of Sample B was the longest, and the cycle lifespan of the nickel-zinc batteries respectively including the negative electrode current collectors of Samples C and D was long next to Sample B. The cycle lifespan of the nickel-zinc batteries respectively including the negative electrode current collectors of Samples A and E was significantly shorter than that of Samples B to D. From the results, it can be said that the cycle lifespan is lengthened in a case where the inner area of the hole 6 is larger than 0.5 mm² and less than 19.6 mm², the cycle lifespan is more lengthened in a case where the inner area of the hole 6 is more than 1.7 mm² and less than 7.0 mm², and the cycle lifespan is still more lengthened in a case where the inner area of the hole 6 is more than 1.7 mm² and less than 3.1 mm².

The negative electrode for a zinc battery and the zinc battery according to the present disclosure are not limited to the embodiment described above, and various modifications can be made. For example, in the embodiment described above, copper and carbon steel were exemplified as an example of the material of the base material, but various materials can be used for the base material as long as the materials have conductivity.

### REFERENCE SIGNS LIST

1: negative electrode for zinc battery, 2: current collector, 3: negative electrode material layer, 4: base material, 5: tin plating film, 6: hole.

1. A negative electrode for a zinc battery, comprising:
a current collector; and
a negative electrode material layer fixed to the current collector,
wherein the current collector has a plurality of holes which pass through the current collector in a thickness direction and are filled with the negative electrode material layer, and
the plurality of holes include a hole having an inner area of larger than 0.5 mm2 and less than 19.6 mm2 in a cross-section orthogonal to the thickness direction.

2. The negative electrode for a zinc battery according to claim 1,
wherein a shape of the cross-section of each of the plurality of holes is a circular shape, and
the plurality of holes include a hole having an inner diameter of larger than 0.8 mm and less than 5 mm in the cross-section.

3. The negative electrode for a zinc battery according to claim 1,
wherein an opening ratio of the current collector is 35% or more.

4. The negative electrode for a zinc battery according to claim 1,
wherein the current collector includes,
a conductive base material, and
a tin plating film that covers at least a part of a surface of the base material.

5. The negative electrode for a zinc battery according to claim 4,
wherein the base material mainly contains carbon steel.

6. The negative electrode for a zinc battery according to claim 1,
wherein the negative electrode material layer contains a zinc-containing component and a binder.

7. A zinc battery, comprising:
the negative electrode for a zinc battery according to claim 1; and
a positive electrode.
